(19) United States
(12) Patent Application Publication
(10) Pub. No.: US 2024/0416162 A1
(43) Pub. Date: Dec. 19, 2024

(54) STANDALONE ELECTRIC VEHICLE FIRE SUPPRESSION PARKING BARRIER

(71) Applicant: Bruno Lucarelli, III, Pompano Beach, FL (US)

(72) Inventor: Bruno Lucarelli, III, Pompano Beach, FL (US)

(21) Appl. No.: 18/653,638

(22) Filed: May 2, 2024

Related U.S. Application Data
(60) Provisional application No. 63/628,006, filed on Jun. 13, 2023.

(51) Int. Cl. A62C 3/02; A62C 3/06

(52) U.S. Cl. CPC A62C 3/0257; A62C 3/06

(57) ABSTRACT

A fire suppression parking barrier to prevent the spread of a vehicle fire is disclosed, including at least one barrier frame assembly and a fire suppression material slidingly engaged over the at least one barrier assembly. A cover slidingly engages over the fire suppression material. The fire suppression parking barrier is capable of preventing the propagation of a fire to other nearby vehicles in a parking area.

### CROSS-REFERENCE TO RELATED APPLICATIONS

The present application claims priority to U.S. Provisional Application No. 63/628,006 filed Jun. 13, 2023, titled “STANDALONE ELECTRIC VEHICLE FIRE SUPPRESSION PARKING BARRIER,” which is hereby incorporated by reference in its entirety.

### TECHNICAL FIELD

The embodiments disclosed herein generally relate to parking barriers which mitigate electric vehicle battery fires.

### BACKGROUND

Electric vehicle battery fires are becoming increasingly more common as these cars are increasing in number. These battery fires burn at temperatures up to 5,000 degrees Fahrenheit and may have the potential to cause significant damage to surrounding vehicles, structures, and pose a significant risk to human life. Currently, parking garages, parking lots, auto dealerships, electric vehicle charging stations and other places where electric vehicles are parked and stored often do not have updated fire suppression systems to compensate for the explosive chemical reactions related to these fires.

Therefore, a need exists to provide a parking barrier that both protects surrounding vehicles and property from the intense heat of these chemical fires and activates a localized fire suppression device to mitigate the fire until more aggressive means can be taken to extinguish the flames.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a fire suppression parking barrier to prevent the spread of a vehicle fire is disclosed, including at least one barrier frame assembly and a fire suppression material slidingly engaged over the at least one barrier assembly. A cover slidingly engages over the fire suppression material. The fire suppression parking barrier is capable of preventing the propagation of a fire to other nearby vehicles in a parking area. The system may be especially useful for preventing the spread of electric vehicles fires which are known to burn at extreme temperatures, causing nearby vehicles to subsequently catch on fire due to the excessive heat.

The fire suppression parking barrier can be deployed in parking areas including indoor and/or outdoor parking areas which allow for the parking and storage of multiple vehicles. The fire suppression parking barrier suppresses a vehicle fire to prevent it's spread to nearby vehicles. This is especially useful for electric vehicles which can cause a fire having extreme temperature exceeding 2500° Fahrenheit. These excessive temperatures can cause nearby vehicles to combust, resulting in a rapidly spreading fire in the parking area.

In one aspect, a first barrier frame and a second barrier frame are connected to one another. The fire suppression barrier may be configured in various lengths and configurations depending on the vehicle which are parked nearby as well as the parking scheme of the vehicles.

In one aspect, the first barrier frame is connected to a second barrier frame using one or more connection members to releasably engage to one or more receivers. The connection members may be provided on a first side of the body portion of the barrier frame, while one or more receivers are provided on a second side of the body portion of the barrier frame.

In one aspect, the one or more receivers each include an aperture to each receive the one or more connection members, allowing their releasably connection. This allows the barrier frames to be connected in a customizable fashion depending on their specific application, vehicles which they are near, and parking scheme.

In one aspect, the cover may include various advertising materials printed or otherwise displayed thereon. This may include logos, colors, textures, and the like which can be chosen by a customer to provide advertising on the exterior surface of the fire suppression parking barrier.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the fire suppression parking barrier, according to some embodiments;

FIG. 2 illustrates a perspective view of the barrier frame, according to some embodiments;

FIG. 3 illustrates a perspective view of the fire suppression material, according to some embodiments;

FIG. 4 illustrates an exploded view of the cover, fire suppression material and barrier, according to some embodiments; and

FIG. 5 illustrates a schematic of the fire suppression parking barriers positioned between vehicles in a parking lot, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a standalone barrier which extends the length and height of an average vehicle, with base plates that enable easy setup and installation. The base plates may be attached to the ground with screws. This barrier also contains mounting elements that will store fire suppression devices that activate upon sensing a fire event on the automobile that is parked next to it. The standalone barrier (referred to herein as “barrier” or “the barrier”) and the mounted devices will isolate the combustion event and mitigate damage to the surrounding vehicles and property. The system will make the task of the professional firefighter responders safer and easier when they arrive on the scene of the electric vehicle fire.

In some embodiments, the barrier has a rectangular construction and may be constructed of metal or other suitable material.

In some embodiments, the barriers may be linked together by an overhead, roof-like structure to further mitigate fire damage and provide shelter for the parked vehicles.

It is to be understood that the barrier and fire suppression system can be utilized in both indoor and outdoor parking areas.

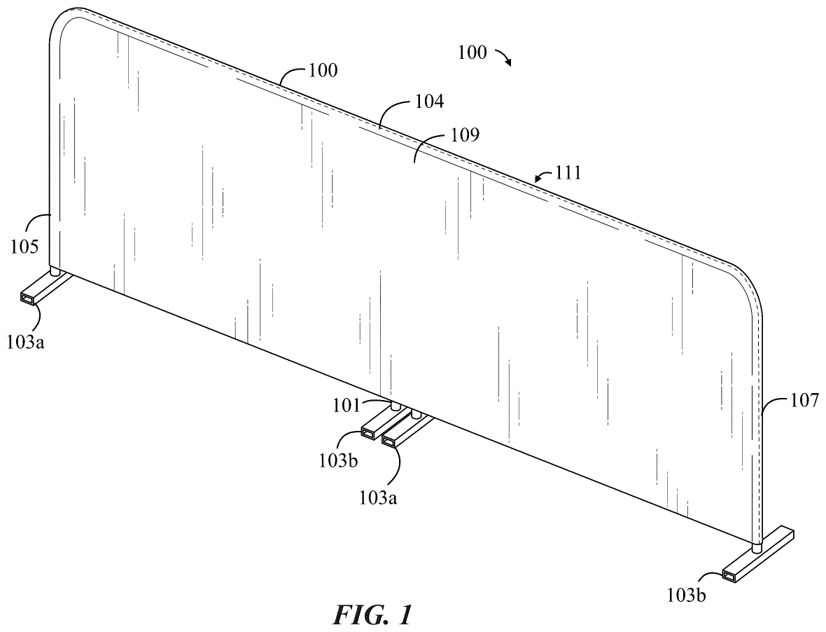

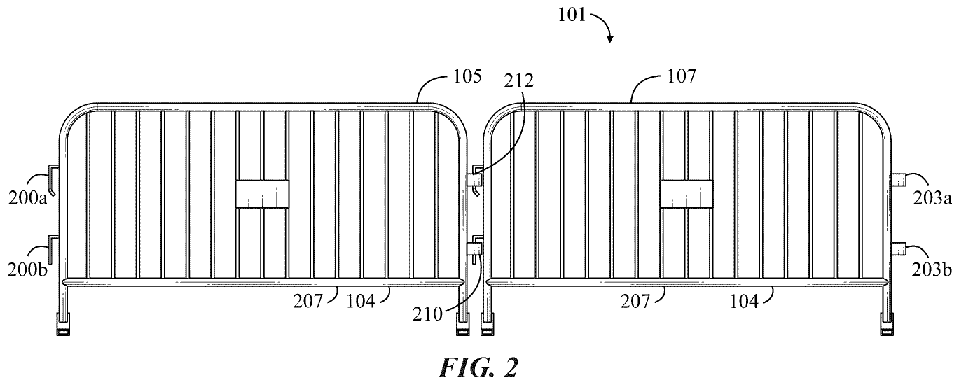

FIG. 1 illustrates a perspective view of the fire suppression parking barrier 100 which includes at least one barrier frame assembly 101 having legs 103a,103b extending from a body portion 104 (see FIG. 2) of the frame assembly 101. The barrier frame assembly 101 can be connected with one another depending on the length which is needed to provide a sufficient fire suppression parking barrier 100 between vehicles. The fire suppression parking barrier includes a fire suppression material which is fit over the at least one frame assembly 101 such that the fire suppression material is retained on the frame, providing a fire suppression barrier on each of the front side 109 and the rear side 111. In such, the fire suppression parking barrier 100 provides a means of suppressing and blocking heat from each side of the barrier to prevent the spread of a vehicle fire between vehicles.

In some embodiments, a first barrier frame 105 and a second barrier frame 107 are connected to provide a fire suppression parking barrier 100 which extends to a length which is adequate for preventing the spread of a vehicle fire to other nearby vehicles. However, one skilled in the arts will readily understand that a plurality of frame assemblies 101 may be connected together to extend to various lengths as is needed for various applications. For example, an electric semi-truck or other long vehicle may require additional frames 101 to be connected to form a longer fire suppression parking barrier. In another use-case, parking lots wherein vehicles are parked end-to-end (such as in vehicle storage facilities, may utilize a plurality of frame assemblies 101 connected in series to create a longer barrier.

FIG. 2 illustrates a perspective view of the barrier frame assembly 101 including a first barrier frame 105 and second barrier frame 107 with the cover and fire suppression material removed therefrom. The first barrier frame 105 and the second barrier frame 107 are connected via a connection members 200a,200b provided on a first side 201 of the body portion 104 and receivers 203a,203b on the second side 205 of the body portion 104. To assembly the barrier frame assembly 101, the first barrier frame 105 is lifted to connect the connection members 200a,200b to the receivers 203a,203b. Once connected, the fire suppression material and cover are slidably engaged with the frame. Each barrier frame assembly 101 includes a first leg 103a and a second leg 103b which are positioned at the bottom 207 of the barrier frame assembly 101. The legs 103a,103b provide a means of retaining the barrier frame assembly 101 in an upright position and prevent the barrier frame assembly 101 from tipping over. The connection members 200a,200b form connection assembly 210 at the central portion 212 of the barrier frame assembly 101.

In some embodiments, each component of the frame assembly 101 is constructed of metal or another rigid material which has fire-resistant properties. The frame assemblies 101 are constructed to withstand the elements (i.e., rain, moisture, snow, sun exposure, etc.) and are capable of long term use in indoor and/or outdoor environments. The frame assemblies 101 may withstand extreme temperatures caused by vehicle fires, and specifically electric vehicle fires which are known to cause temperatures near 5000° Fahrenheit.

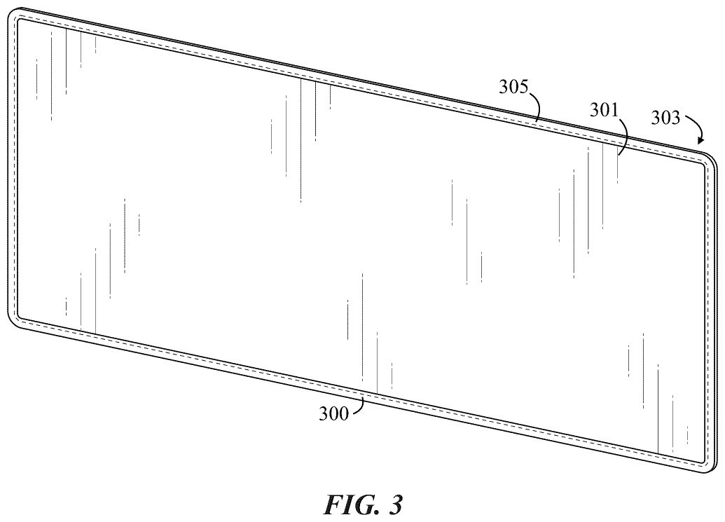

FIG. 3 illustrates a perspective view of the fire suppression material 300 which is configured to be slidingly engaged with the frame assembly. The first suppression material includes a first surface 301 integrally connected with a second surface 303 via a top portion 305. The top portion 305 rests on the top of the barrier frame assembly to prevent the fire suppression material from sliding further down the barrier frame assembly while ensuring the fire suppression material cover the entire barrier frame assembly to prevent the spread of a fire between parked vehicles. The fire suppression material may be constructed of materials which are commonly used to create a fire blanket which is used to suppress an active fire. The fire suppression material is effective for suppressing fires and preventing the transfer of extreme heat to the environment on the opposing side of the barrier frame assembly.

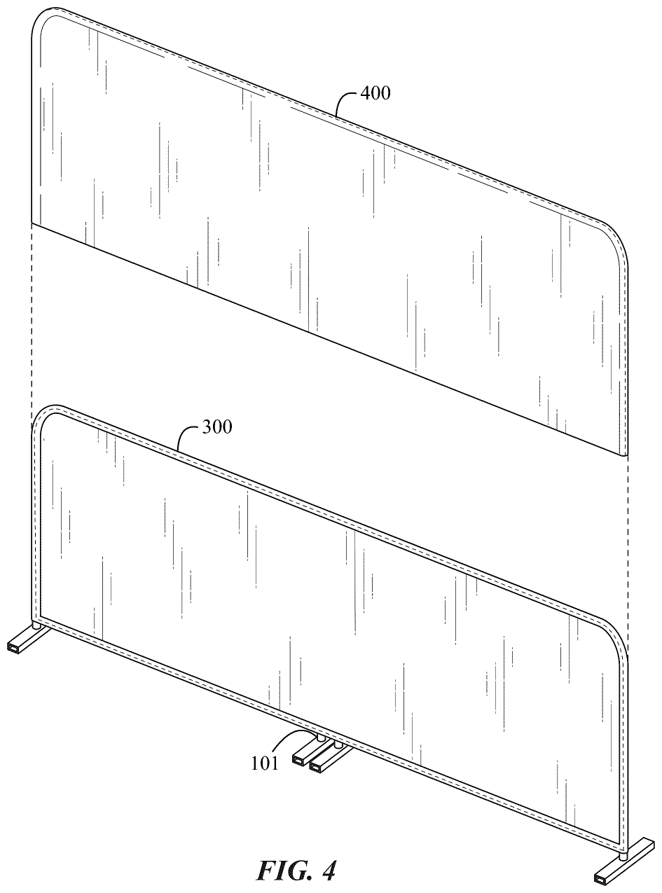

FIG. 4 illustrates an exploded view of the cover 400, fire suppression material 300 and barrier frame assembly 101, wherein the cover 400 is removed from the barrier frame assembly 101 to expose the fire suppression material 300 retained on the barrier frame assembly 101. The cover 400 is dimensioned such that it slidingly engages over the fire suppression material 300 when both components are covering the barrier frame assembly 101.

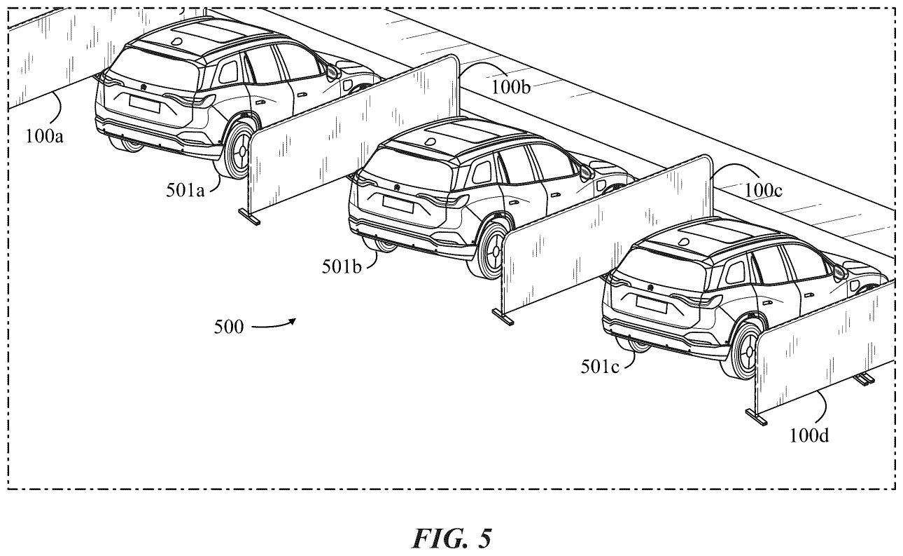

FIG. 5 illustrates a schematic of the fire suppression parking barriers 100 (illustrated as 100a,100b,100c,100d) positioned between vehicles in a parking lot 500. The fire suppression parking barriers 100 are positioned between vehicles 501a,501b,501c to suppress or at least prevent a fire from spreading between one or more vehicles. This allows for emergency personnel (i.e., firemen, etc.) to arrive on scene to extinguish the fire without the firing actively spreading between vehicles.

While one skilled in the art will readily understand that the fire suppression parking barriers may be configured in various sizes and configuration, in one particular example, the fire suppression parking barriers are no more than 42-inches in height such that drivers can see above the barriers while parking or moving the vehicle.

In some embodiments, the fire suppression material is capable of providing a thermal

barrier for fires that reach temperatures of at least 2500° Fahrenheit.

In some embodiments, each of the barrier frames may be 7-feet in length. Once linked together as described above, the fire suppression parking barriers may exceed 7-feet in length, such as by being 14-feet in length in an embodiment wherein two barrier frames are linked together. While used an example, the length of the barrier frames is non-limiting and utilizing barrier frames of different lengths to construct a fire suppression parking barrier of any length is considered and included by the description of the embodiments disclosed herein.

In some embodiments, the cover may include advertising material which may cover the fire suppression material. The cover may be used for advertising purposes or may be used to provided additional properties which provide fire suppression. The advertising material can be constructed of various materials having various logos, colors, or other advertising materials thereon.

In some embodiments, the fire suppression material is configured as a “slipcover” to slidingly engage with the frame. In such, the fire suppression material can be easily removed from the barrier frames to be used as a fire blanket.

The fire suppression material can be constructed of any known materials in the arts which are used as a “fire blanket” or similar fire suppression device. The fire suppression material can be used to suppress an active vehicle fire and thus prevent the spread of the vehicle fire to nearby vehicles.

In some embodiments, the fire suppression parking barrier may be a component of a fire suppression system configured to monitor a parking area and provide a response and/or alert towards the presence of a fire.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A fire suppression parking barrier to prevent the spread of a vehicle fire comprising:
at least one barrier frame assembly;
a fire suppression material slidingly engaged over the at least one barrier assembly; and
a cover slidingly engaged over the fire suppression material.

2. The fire suppression parking barrier of claim 1, wherein the fire suppression material is configured to suppress fire created by an electric vehicle.

3. The fire suppression parking barrier of claim 2, wherein the fire suppression material is capable to suppressing a fire having a temperature of at least 2500° Fahrenheit.

4. The fire suppression parking barrier of claim 1, wherein a first barrier frame and a second barrier frame are connected to one another.

5. The fire suppression parking barrier of claim 1, wherein a first barrier frame is connected to a second barrier frame using one or more connection members to releasably engage to one or more receivers.

6. The fire suppression parking barrier of claim 5, wherein the one or more connection members are provided on a first side of a body portion.

7. The fire suppression parking barrier of claim 6, wherein the one or more receivers are provided on a second side of the body portion.

8. The fire suppression parking barrier of claim 7, wherein the one or more receivers each include an aperture to each receive the one or more connection members.

9. The fire suppression parking barrier of claim 1, wherein the cover includes a plurality of advertising material.

10. A fire suppression parking barrier to prevent the spread of a vehicle fire comprising:
at least one barrier frame assembly including a first barrier frame and a second barrier frame;
a fire suppression material slidingly engaged over the at least one barrier assembly to prevent the spread of a fire between vehicles parked in a parking area; and
a cover slidingly engaged over the fire suppression material.

11. The fire suppression parking barrier of claim 10, wherein the fire suppression material is configured to suppress fire created by an electric vehicle causing a fire to burn at a temperature of at least 2500° Fahrenheit.

12. The fire suppression parking barrier of claim 10, wherein a first barrier frame and a second barrier frame are connected to one another via one or more connection members to releasably engage to one or more receivers.

13. The fire suppression parking barrier of claim 12, wherein the one or more connection members are provided on a first side of a body portion.

14. The fire suppression parking barrier of claim 13, wherein the one or more receivers are provided on a second side of the body portion.

15. The fire suppression parking barrier of claim 14, wherein the one or more receivers each include an aperture to each receive the one or more connection members.

16. The fire suppression parking barrier of claim 15, wherein the cover includes a plurality of advertising material.

17. The fire suppression parking barrier of claim 16, wherein each of the at least one barrier frame assemblies include a plurality of legs.

18. The fire suppression parking barrier of claim 17, wherein the fire suppression material includes a first surface and a second surface integrally connected to a top portion.

19. The fire suppression parking barrier of claim 18, wherein the cover includes a first cover surface and a second cover surface integrally connected to a top cover portion.

20. A fire suppression parking barrier to prevent the spread of a vehicle fire comprising:
at least one barrier frame assembly including a first barrier frame and a second barrier frame, wherein each of the first barrier frame and the second barrier frame include a plurality of legs to retain the at least one barrier frame assembly in an upright position;
a fire suppression material slidingly engaged over the at least one barrier assembly to prevent the spread of a fire between vehicles parked in a parking area; and
a cover slidingly engaged over the fire suppression material, the cover to display advertising material thereon.
